(19) United States
(12) Patent Application Publication
(10) Pub. No.: US 2023/0384161 A1
(43) Pub. Date: Nov. 30, 2023

(54) METHOD FOR CHARACTERIZATION OF TEMPERATURE IN WELD ZONE OF FRICTION STIR WELDING BASED ON INFRARED THERMAL IMAGER

(71) Applicant: DALIAN UNIVERSITY OF TECHNOLOGY, Dalian (CN)

(72) Inventors: Xiaohong LU, Dalian (CN); Guochuan SUI, Dalian (CN); Zhenyuan JIA, Dalian (CN); Shixuan SUN, Dalian (CN); Le TENG, Dalian (CN)

(21) Appl. No.: 18/108,966

(22) Filed: Feb. 13, 2023

(30) Foreign Application Priority Data
May 31, 2022 (CN) 202210609308.0

(51) Int. Cl. G01J 5/00; G01J 5/48; G06F 30/27

(52) U.S. Cl. CPC G01J 5/0003; G01J 5/485; G06F 30/27; G01J 2005/0077; G06F 2111/10

(57) ABSTRACT

The present invention belongs to the field of friction stir welding (FSW) temperature detection, and relates to a temperature characterization method of FSW weld zone based on infrared thermal imager. The invention combines theory with experiment. A temperature field simulation model of FSW is established based on DEFORM. The data sets of temperature of surface feature points, the maximum and minimum temperatures in weld zone are obtained according to the simulation model result. Then, Support Vector Regression (SVR) is used to establish a temperature characterization model, which represents the correlation between the temperature of surface feature points and the maximum and minimum temperatures in weld zone. In the actual welding process, an infrared camera is used to measure the temperature of the surface feature point in real-time. Combined with the built temperature characterization model, the characterization of the maximum and minimum temperatures in weld zone is achieved.

### TECHNICAL FIELD

The present invention belongs to the temperature detection field of friction stir welding (FSW), and relates to a temperature characterization method of weld zone during friction stir welding based on infrared thermal imager. The temperature in weld zone of friction stir welding is characterized by a thermal imager, a finite element simulation model and a support vector regression (SVR) machine algorithm.

### BACKGROUND

FSW is a new type of solid welding technology. The heat generated by the friction between the high-speed rotating tool and the weldment during welding softens the material. The welding material undergoes plastic flow under the action of the tool movement, and finally forms a weld under the extrusion of the tool shoulder and the stir pin. FSW has the advantages of high welding efficiency, pollution free, and excellent weld mechanical properties of welded joints and is commonly used in welding aluminum and magnesium alloys.

The weld zone of FSW is composed of nugget zone (NZ), thermo-mechanical affected zone (TMAZ), and heat-affected zone (HAZ). The temperature of the weld zone directly affects the microstructure of the welded joint and ultimately affects its mechanical properties. The temperature in the weld zone is also the basis of other related research such as the flow of plastic material in the weld, the transformation of the joint's metallographic structure, the optimization of welding parameters, and the analysis of welding mechanism. Due to the rotation of the tool, the occlusion of the stirrer shoulder, the severe plastic deformation of the weldment material under thermo-mechanical effects, direct measurement of temperature in the weld zone during the welding process is difficult to characterize the temperature distribution in weld zone. There are many methods to measure the temperature field of FSW, such as thermocouple and infrared thermal imager. Inserting thermocouples in the weldment will destroy the workpiece, and the measurement results are not repeatable, often used in experimental research, and can't be used in engineering. Embedding thermocouples in the tool will reduce the strength and stiffness of the tool, ultimately affecting the tool's service life. Infrared thermography can only measure the surface temperature of the weldment. The finite element simulation could simulate the welding process and realize the characterization of the temperature field in the weld zone. However, the simple numerical simulation method can only characterize the temperature field in the weld zone under the given parameters, and cannot track the changes of the temperature online.

### SUMMARY

The technical problem to be solved by the invention is to overcome the shortcomings of the existing technology, and to invent a weld zone's temperature characterization method of FSW based on infrared thermal imager. The obtained temperature in the weld zone during welding provides a basis for the study of welding mechanism. Firstly, a temperature field simulation model of FSW is established to obtain data sets of temperature of surface feature points, the maximum and minimum temperatures in weld zone; Then, SVR is used to establish a temperature characterization model, which represents the correlation between the temperature of surface feature points and the maximum and minimum temperatures in weld zone; Finally, in the actual welding process, an infrared camera is used to measure the temperature of the surface feature point in real-time. Combined with the built temperature characterization model, the characterization of the maximum and minimum temperatures in weld zone is achieved.

The technical solution of the present invention is as follows:

The present invention is a temperature characterization method of FSW weld zone based on infrared thermal imager. The invention combines theory with experiment. A temperature field simulation model of FSW is established. The data sets of temperature of surface feature points, the maximum and minimum temperatures in weld zone are obtained according to the simulation model result. Then, Support Vector Regression (SVR) is used to establish a temperature characterization model, which represents the correlation between the temperature of surface feature points and the maximum and minimum temperatures in weld zone; In the actual welding process, an infrared camera is used to measure the temperature of the surface feature point; Combining the real-time temperature of the surface feature point on the weldment measured by infrared thermal imager with the characterization model based on SVR, the characterization of the maximum and minimum temperatures in weld zone is achieved during FSW; The method comprises the following steps:
step 1. A temperature field simulation model of FSW is established;
step 2. The data sets of temperature of surface feature points, the maximum and minimum temperatures in weld zone are extracted according to the simulation model result;
step 3. To design support vector regression machine algorithm model; The usual starting point is a sample dataset (x₁, y₁), . . . , (x_{N}, y_{N}), where xᵢ (i=1, . . . , N) is the surface characteristic point temperature of the weldment, which is a one-dimensional input; yᵢ (i=1, . . . , N) is the weld zone temperature including the maximum temperature and the minimum temperature, which is a one-dimensional target; The basic idea of SVR is to map the data in the original input space into a high-dimensional feature space through a nonlinear transformation φ(x). In this high-dimensional feature space, the ε-insensitive loss function is used for linear regression to obtain the nonlinear regression relationship between the target quantity and the input quantity in the original space. The relationship between the surface temperature of weldment and the temperature of weld zone is obtained; the optimal linear function constructed in high dimensional feature space:

f(x)=w^{T}*ϕ(x)+b (1)

Where w is the weight vector, b is the bias term; the ε-insensitive loss function is defined as:

$${L}_{ε} ( z ) = \{ \begin{matrix}0 , & \vert z \vert \leq ε \\ \vert z \vert - ε , & otherwi s e\end{matrix} \qquad ( 2 )$$

The objective function of SVR optimization is then as follows:

$$\begin{matrix}min \{ \frac{1}{2} {‖ w ‖}^{2} + C {\sum }_{i = 1}^{N} {L}_{ε} ( f ( {x}_{i} ) - {y}_{i} ) \} \\ s . t . {y}_{i} - ( {w}^{T} \cdot φ ( {x}_{i} ) + b ) \leq ε + {ξ}_{i}^{*} \\ {w}^{T} \cdot φ ( {x}_{i} ) + b - {y}_{i} \leq ε + {ξ}_{i}\end{matrix} \qquad ( 3 )$$

Where C>0 is the penalty coefficient, considering the possible errors and introducing two slack variables ξᵢ,ξ*ᵢ, the optimization function is then as follows:

$$\begin{matrix}min \{ \frac{1}{2} {‖ w ‖}^{2} + C {\sum }_{i = 1}^{N} ( {ξ}_{i} + {ξ}_{i}^{*} ) \} \\ s . t . {y}_{i} - ( {w}^{T} \cdot φ ( {x}_{i} ) + b ) \leq ε + {ξ}_{i}^{*} \\ {w}^{T} \cdot φ ( {x}_{i} ) + b - {y}_{i} \leq ε + {ξ}_{i} \\ {ξ}_{i} , {ξ}_{i}^{*} \geq 0\end{matrix} \qquad ( 4 )$$

To solve formula (4), the Lagrange function is introduced:

$$L ( w , b ; α , {α}^{*} ) = \frac{1}{2} {‖ w ‖}^{2} - {\sum }_{i = 1}^{N} {α}_{i} ( ε + {y}_{i} - ( w \cdot φ ( {x}_{i} ) + b ) ) - {\sum }_{i = 1}^{N} {α}_{i}^{*} ( ε - {y}_{i} + ( w \cdot φ ( {x}_{i} ) + b ) ) \qquad ( 5 )$$

where, α=[α₁, . . . , α_{N}]^{T}≥0, α*=[α*₁, . . . , α*_{N}]^{T}≥0 is the Lagrange multiplier; taking partial differential of w and b respectively and making them equal to 0, the dual problem of Equation (5) is:

$$\begin{matrix}min \frac{1}{2} {\sum }_{i , j = 1}^{N} ( {α}_{i} - {α}_{i}^{*} ) ( {α}_{j} - {α}_{j}^{*} ) k ( {x}_{i} , {x}_{j} ) + ε {\sum }_{i = 1}^{N} ( {α}_{i} + {α}_{i}^{*} ) - {\sum }_{i = 1}^{N} {y}_{i} ( {α}_{i} - {α}_{i}^{*} ) \\ s . t . {\sum }_{i = 1}^{N} ( {α}_{i} - {α}_{i}^{*} ) = 0 \\ 0 \leq {α}_{i}^{*} \leq C , 0 \leq {α}_{i} \leq C , i = 1 , … , N\end{matrix} \qquad ( 6 )$$

Where k(xᵢ,xⱼ) is the kernel function, RBF kernel function is selected, which has the advantages of good smoothness, radial symmetry and simple parameters. The function is as follows:

$$k ( {x}_{i} , {x}_{j} ) = {e}^{\frac{{‖ {x}_{i} - {x}_{j} ‖}^{2}}{2 {σ}^{2}}} \qquad ( 7 )$$

where σ>0 is an adjustable nuclear parameter;

Solve Equation (6) to obtain a regression estimate of SVR as follows:

$$f ( x ) = {\sum }_{i , j = 1}^{N} ( {α}_{i} - {α}_{i}^{*} ) k ( {x}_{i} , {x}_{j} ) + b \qquad ( 8 )$$

step 4. Setting the parameters and kernel function of the support vector regression algorithm model. The divided training and test temperature data sets of the feature point and weld zone are inputted in the model.
step 5. Taking the root mean square error as the evaluation standard, the support vector regression machine algorithm model in step 3 is trained and tested.
step 6. The infrared thermal imager is arranged in front of the FSW machine, and the friction stir welding experiments are carried out. The temperature of the surface feature point on the weldment during the welding is obtained by the infrared thermal imager. Taking the temperature of the feature points on the weldment as input to predict the maximum and minimum temperatures of the weld zone during the welding.

### DESCRIPTION OF DRAWINGS

FIG. 1 is a schematic diagram of a three-dimensional simulation model after assembly.

FIG. 2 is a schematic diagram of temperature-dependent material properties of 2219 aluminum alloy

FIG. 3 is a schematic diagram of the simulation model after meshing

FIG. 4 is a schematic diagram of the maximum temperature extraction in the weld zone

FIG. 5 is a schematic diagram of the advancing side feature point

FIG. 6 is a schematic diagram of the minimum temperature extraction in the weld zone

FIG. 7 is a schematic diagram of the retreating side feature point

FIG. 8 is a schematic diagram of the maximum and minimum temperatures in the weld zone predicted by SVR.

### DETAILED DESCRIPTION

Specific embodiments of the present invention are further described below in combination with the drawings and the technical solutions.

In this embodiment, 2219 aluminum alloy is used as welding material. 2219 aluminum alloy has good high temperature mechanical properties, welding performance and stress corrosion resistance, and is widely used in aerospace field.

The data sets of temperature of surface feature points, the maximum and minimum temperatures in weld zone are obtained according to the simulation model result. Then, Support Vector Regression (SVR) is used to establish a correlation between the temperature of surface feature points and the maximum and minimum temperatures in weld zone. Combined with surface temperature of FSW weldments based on infrared camera, the characterization of the maximum and minimum temperatures in weld zone is achieved.

Step 1. Establishment of the temperature field simulation model of FSW

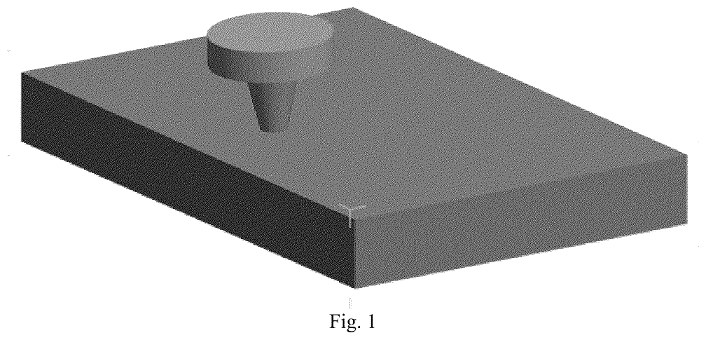

Geometrical Model: SolidWorks was used to establish the model of weldment and tool and imported into DEFORM software for assembly. The parameters of the tool are shown in the following table 1. The welding material is 2219 aluminum alloy and the size is 100 mm×150 mm×18 mm. The three-dimensional simulation model after assembly in DEFORM is shown in FIG. 1.

TABLE 1
Parameters of the tool

| Radius of the | Shoulder | Stir pin root | Stir pin top | Length of |
|---|---|---|---|---|
| shoulder | concave angle | diameter | diameter | stir pin |
| 32 mm | 4° | 15 mm | 7 mm | 17.8 mm |

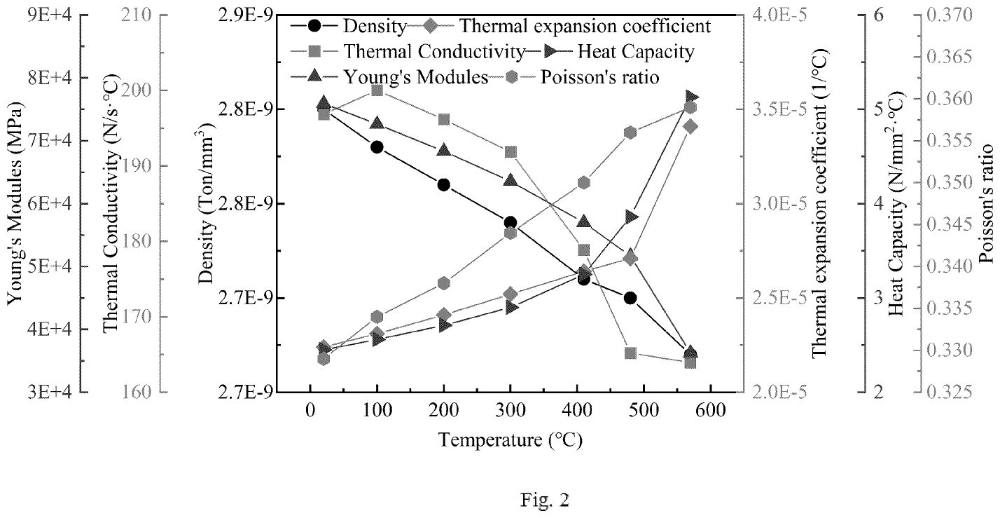

Material Properties: The chemical composition of 2219 aluminum alloy is shown in Table 2. The temperature-dependent material properties of 2219 aluminum alloy are obtained by utilizing JmatPro software, as shown in FIG. 2.

TABLE 2
Chemical composition of 2219 aluminum alloy

| Cu | Mn | Fe | Si | Zn | V | Ti | Zr | Mg | Al |
|---|---|---|---|---|---|---|---|---|---|
| 6.21 | 0.29 | 0.12 | 0.15 | 0.06 | 0.08 | 0.03 | 0.12 | 0.02 | Bal |

Johnson-Cook constitutive model is used to describe the effect of material flow stress on temperature and strain rate. Johnson-Cook constitutive equation is written as:

$$σ = ( A + B {ε}^{n} ) ( 1 + C ln {\dot{ε}}^{*} ) ( 1 - {( {T}^{*} )}^{m} ) \qquad ( 9 )$$

$${T}^{*} = \{ \begin{matrix}0 & T < {T}_{r o o m} \\ ( \frac{T - {T}_{r o o m}}{{T}_{melt} - {T}_{r o o m}} ) & {T}_{r o o m} \leq T \leq {T}_{melt} \\ 1 & T > {T}_{melt}\end{matrix} \qquad ( 10 )$$

Where ε presents the effective plastic strain; \dot{ε}* presents the relative plastic strain rate, \dot{ε}*=\dot{ε}/\dot{ε}₀; \dot{ε} presents the effective plastic strain rate; \dot{ε}₀ presents the reference plastic strain rate. Tᵣₒₒₘ is the indoor temperature, Tₘₑₗₜ is the melting point of the material. The constants of the constitutive equation of 2219 aluminium alloy are shown in Table 3.

TABLE 3
Material constants for the Johnson-Cook model

| A (MPa) | B (MPa) | n | C | m |
|---|---|---|---|---|
| 170 | 228 | 0.31 | 0.028 | 2.75 |

The material of the tool is H13 tool steel. The material constitutive equation uses the data in the material library of DEFORM software. Other material parameters are shown in Table 4.

TABLE 4
material parameters of H13

| | | | | Thermal | |
|---|---|---|---|---|---|
| | Thermal | | | expansion | Young's |
| Temperature | conductivity | Heat capacity | Density | coefficient | modulus |
| (° C.) | (N/s*° C.) | (N/mm\hat{ }2*° C.) | (Ton/mm\hat{ }3) | (1/° C.) | (MPa) |
| 20 | 25.0 | 3.6 | 7.81e−9 | 1.10 | 215000 |
| 499 | 27.7 | 4.2 | 7.64e−9 | 1.15 | 176000 |
| 593 | 30.4 | 4.5 | 7.64e−9 | 1.24 | 165000 |

Boundary conditions: Boundary conditions are divided into mechanical boundary conditions and thermal boundary conditions. In the setting of mechanical boundary conditions, the degree of freedom of movement in the Z direction of the weldment bottom surface is limited, and the degree of freedom of movement in the X and Y directions of the weldment side is limited to avoid the displacement of the weldment during the simulation process. Heat convection coefficient between the bottom surface of the weldment and air is set as 5 N/mm·s·° C., and heat convection coefficient between the remaining surface of the weldment, the surface of the tool, and air is set as 0.025 N/mm·s·° C.

Frictional mode: During the welding process, the temperature of the contact area between the weldment and tool increases, the surface of the weldment material with lower strength is partially sheared. Under the action of friction, part of the weldment material will be stick to the surface of the tool. To describe the state of the contact area between the weldment and tool during the welding process accurately, a shear friction model that changes with temperature is adopted. The equation is expressed as:

τ=mk (11)

Where τ is the contact stress at the interface of the weldment and tool; m is the shear factor; k is the shear strength. The coefficients of friction are temperature-dependent, as shown in Table 5.

TABLE 5
Temperature-dependent coefficients of friction

| Temperature (° C.) | 25 | 100 | 200 | 300 | 400 | 500 |
|---|---|---|---|---|---|---|
| m | 0.61 | 0.51 | 0.21 | 0.07 | 0.47 | 0.01 |

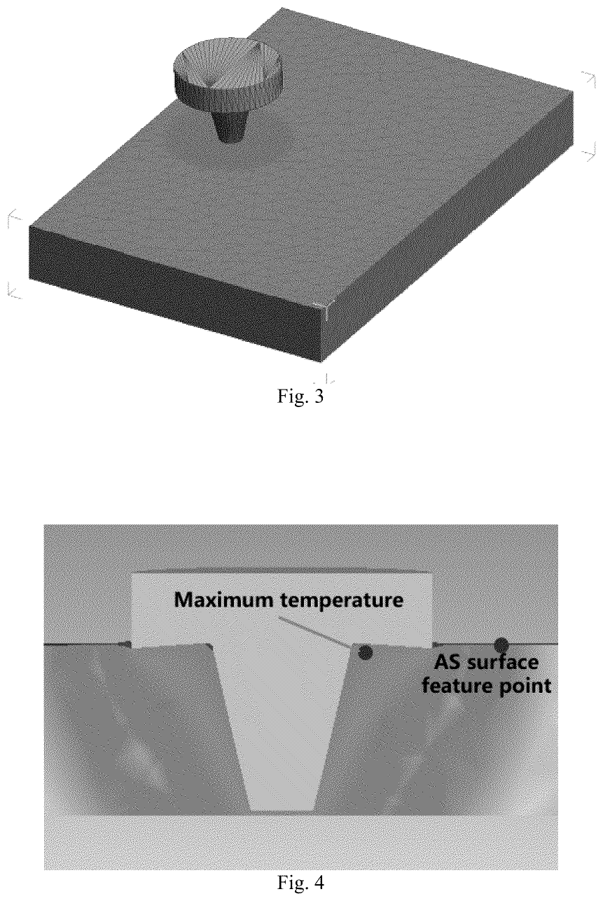

Grid division: The choice of mesh type and size is a very important factor affecting the accuracy of finite element analysis. The model needs mesh generation of the tool and weldment. The number of grids affect the simulation calculation time. The contact area between the weldment and the tool is refined, and other areas use coarse grids to reduce the simulation time. The simulation model completed by meshing is shown in FIG. 3.

Based on the established simulation model, the simulation of the rotation speed of the tool is 500 r/min, the welding speed is 75 mm/min, the pressing speed is 15 mm/min, the tool tilt angle is 2.5°, and the pressing amount is 0.2 mm. The temperature field under this set of welding process parameters is obtained.

step 2. To extract the data sets of temperature of surface feature point and temperatures in weld zone according to the simulation model result.

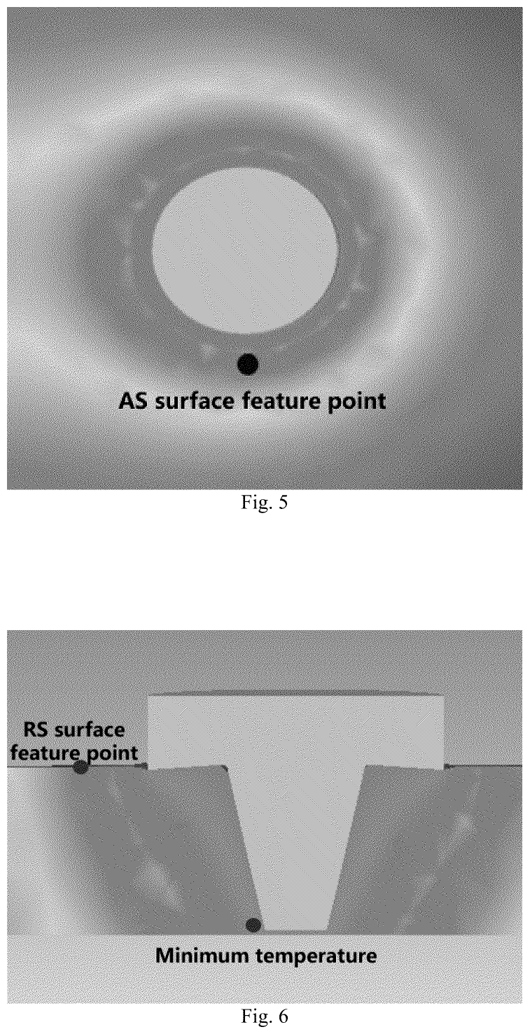

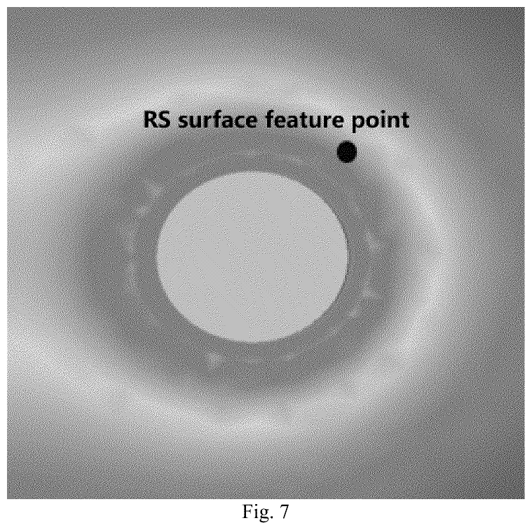

The maximum temperature of the weld zone is distributed below the tool shoulder as shown in FIG. 4. Based on the FSW finite element simulation model established by the above steps, the temperature of the feature point on the advancing side (AS) of the weldment surface and the maximum temperature of the weld zone are extracted. The data sets are shown in Table 6, and the position of the feature point on the AS is shown in FIG. 5. The minimum temperature of the weld zone is distributed at the bottom of the weldment as shown in FIG. 6. The temperature of the feature point on the retreating side (RS) of the weldment and the minimum temperature data sets of the core area are extracted from the simulation model as shown in Table 6. The position of the feature point on the RS is shown in FIG. 7.

TABLE 6
Temperature of surface feature point
and the temperature in wed zone (° C.)

| No. | T_{AS} | T_{RS} | Tₘₐₓ | Tₘᵢₙ |
|---|---|---|---|---|
| 1 | 290.8 | 264.2 | 493.6 | 422.5 |
| 2 | 316.8 | 240.7 | 503.8 | 411.5 |
| 3 | 296.9 | 255.6 | 496.7 | 416.8 |
| 4 | 305.3 | 244.5 | 498.6 | 413.3 |
| 5 | 319.0 | 245.4 | 503.9 | 413.8 |
| 6 | 313.0 | 281.4 | 500.3 | 436.9 |
| 7 | 326.0 | 249.9 | 506.6 | 414.4 |
| 8 | 307.4 | 251.7 | 497.8 | 416.4 |
| 9 | 307.0 | 252.4 | 498.8 | 416.2 |
| 10 | 335.2 | 248.4 | 508.1 | 416.0 |
| 11 | 327.8 | 254.2 | 506.9 | 416.5 |
| 12 | 308.9 | 256.7 | 499.9 | 419.0 |
| 13 | 301.2 | 257.8 | 496.6 | 418.1 |
| 14 | 285.4 | 259.0 | 490.6 | 418.6 |
| 15 | 300.5 | 259.8 | 497.8 | 419.5 |
| 16 | 292.3 | 278.5 | 494.6 | 433.3 |
| 17 | 297.6 | 263.7 | 496.0 | 420.5 |
| 18 | 313.5 | 238.8 | 501.8 | 410.0 |
| 19 | 296.2 | 265.5 | 495.7 | 423.1 |
| 20 | 322.1 | 242.5 | 504.9 | 411.9 |
| 21 | 302.8 | 283.3 | 497.6 | 439.8 |
| 22 | 323.3 | 269.9 | 505.5 | 426.4 |
| 23 | 309.8 | 266.2 | 499.4 | 425.2 |
| 24 | 328.6 | 273.0 | 505.2 | 429.1 |
| 25 | 312.0 | 239.1 | 500.0 | 412.7 |
| 26 | 303.2 | 240.3 | 497.8 | 413.6 |
| 27 | 313.6 | 243.6 | 501.5 | 413.4 |
| 28 | 330.9 | 245.4 | 507.3 | 414.1 |
| 29 | 298.5 | 246.9 | 496.9 | 415.8 |
| 30 | 310.3 | 247.1 | 500.2 | 413.8 |
| 31 | 319.7 | 253.4 | 504.5 | 417.3 |
| 32 | 320.8 | 249.6 | 505.2 | 416.5 |
| 33 | 325.2 | 255.2 | 506.3 | 419.8 |
| 34 | 304.9 | 264.4 | 498.4 | 423.9 |
| 35 | 308.0 | 256.5 | 498.7 | 419.9 |
| 36 | 321.1 | 257.5 | 503.5 | 420.8 |
| 37 | 318.1 | 258.7 | 502.9 | 419.8 |
| 38 | 340.6 | 260.5 | 510.0 | 420.3 |
| 39 | 312.4 | 261.7 | 500.7 | 421.2 |
| 40 | 299.2 | 253.7 | 497.5 | 418.8 |
| 41 | 329.8 | 270.3 | 507.1 | 425.7 |
| 42 | 288.9 | 267.5 | 493.5 | 427.0 |
| 43 | 317.0 | 278.4 | 502.3 | 434.7 |
| 44 | 287.5 | 252.3 | 492.5 | 416.8 |
| 45 | 289.6 | 275.3 | 492.7 | 432.1 |
| 46 | 304.3 | 252.5 | 497.6 | 417.3 |
| 47 | 311.6 | 266.6 | 501.2 | 424.2 |
| 48 | 286.7 | 258.4 | 491.5 | 418.5 |

T_{AS} represents the temperature of the surface feature point on AS, T_{RS} represents the temperature of the surface feature point on RS, Tₘₐₓ represents the maximum temperature in weld zone, Tₘᵢₙ represents the minimum temperature in weld zone.

step 3. FSW experiments are carried out, and the temperatures of the weld zone and the surface temperature of the weldment are measured by thermocouple and infrared thermal imager respectively.

The maximum and minimum temperatures of the weld zone during FSW are obtained by thermocouple to test the characterization accuracy of this method. The K-type thermocouple is selected as the temperature measuring element, and the temperature transmitter performs nonlinear correction on the temperature signal. The PCI-1747U data acquisition card collects the temperature signal and transmits it to the host computer. The thermocouples are arranged at the feature points of 1.5 mm from the upper surface, 115 mm from the weld center, 1.5 mm from the lower surface, and 119 mm from the weld center. The AS and RS are symmetrically arranged.

In the experiment, a 2219 aluminum alloy welding plate with a size of 300 mm×120 mm×18 mm is used, and a hole was drilled on the side of the welding plate to embed thermocouples. The thermal imager is arranged in front of the weldment, and the angle with the spindle was 30°. The FSW experiment is carried out. The rotation speed of the tool is 500 r/min, the welding speed is 75 mm/min, the pressing speed is 15 mm/min, and the tool tilt angle is 2.5°. In the experiment, the feed is completed by the movement of the workbench. The relative position of the machine tool spindle and the thermal imager remains unchanged. The temperature of the characteristic points on the surface of the weldment during FSW is obtained as follows:

TABLE 7
Temperature of the surface feature point on AS

| No. | 1 | 2 | 3 | 4 | 5 | 6 | 7 | 8 | 9 | 10 |
|---|---|---|---|---|---|---|---|---|---|---|
| Temp. | 303.2 | 310.6 | 320.9 | 314.2 | 309.4 | 325.0 | 313.1 | 328.2 | 310.9 | 321.9 |

TABLE 8
Temperature of the surface feature point on RS

| No. | 1 | 2 | 3 | 4 | 5 | 6 | 7 | 8 | 9 | 10 |
|---|---|---|---|---|---|---|---|---|---|---|
| Temp. | 255.3 | 263.8 | 245.6 | 273.0 | 262.2 | 255.9 | 267.7 | 247.8 | 251.4 | 277.8 |

step 4. The characterization model between the surface temperature and weld zone temperature is established, and the characterization of temperature in weld zone during FSW is realized by combining the surface temperature measured by thermal imager.

The SVR algorithm is as follows:

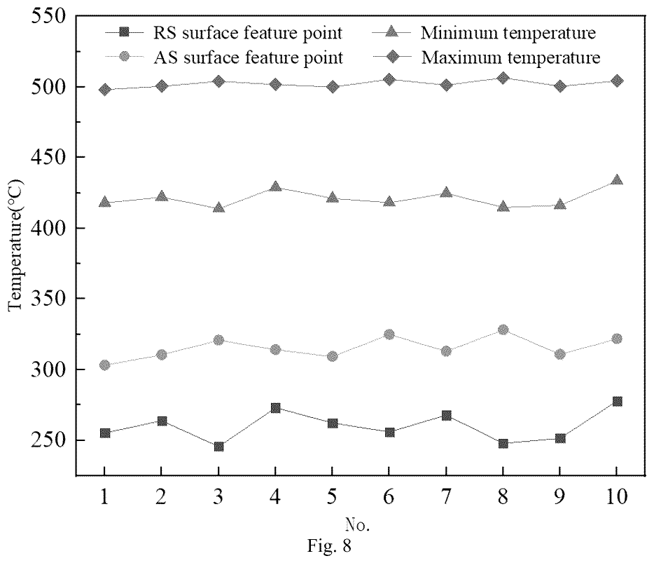

According to the temperature of the weldment's surface feature point on AS and the maximum temperature of the weld zone given in Table 6, the temperature of the weldment's surface feature point on AS is taken as input, and the maximum temperature of the weld zone is taken as target. The SVR algorithm is used to establish a correlation between the temperature of the weldment's surface feature point on AS and the maximum temperature in weld zone. Combined with the surface temperature of FSW weldment on AS based on infrared camera, the characterization of the maximum temperature in the weld zone is achieved. Similarly, the SVR algorithm is used to establish a correlation between the temperature of the weldment's surface feature point on RS and the minimum temperature in weld zone. Combined with the surface temperature of FSW weldment on RS based on infrared camera, the characterization of the minimum temperature in the weld zone is achieved. The maximum and minimum temperatures of the weld zone obtained by this method are shown in FIG. 8. The maximum and minimum temperatures of the weld zone measured by the thermocouple in the experiment and the temperature results predicted by the SVR algorithm are shown in Table 9, and the prediction accuracy in the weld zone of this method is shown in Table 10.

TABLE 9
Prediction of temperatures in weld zone (° C.)

| | Predicted | Measured | Predicted | Measured |
|---|---|---|---|---|
| | maximum | maximum | minimum | minimum |
| No. | temperature | temperature | temperature | temperature |
| 1 | 501.8 | 508.0 | 413.9 | 434.1 |
| 2 | 505.3 | 513.4 | 421.3 | 442.3 |

TABLE 10
Prediction accuracy of maximum and minimum
temperatures in weldment weld zone (° C.)

| | Mean relative | Maximum relative | Root mean |
|---|---|---|---|
| | percentage error | percentage error | square error |
| Maximum | 1.40% | 1.58% | 7.21 |
| temperature | | | |
| Minimum | 4.70% | 4.75% | 20.60 |
| temperature | | | |

Aiming at the FSW of 2219 aluminum alloy, a finite element simulation model of FSW is established based on DEFORM. The data sets of temperature of surface feature points, the maximum and minimum temperatures in weld zone are extracted from the simulation result. Then, the SVR algorithm was used to establish the correlation between the surface temperature and the maximum and minimum temperatures of weld zone. Finally, a friction stir welding experiment is carried out. Combined with the surface temperature of the weldment measured by thermal imager, the characterization of the maximum and minimum temperatures in weld zone is achieved during FSW. Compared with the temperature results measured by thermocouples, the error of this method is less than 5%, and the accuracy is high. The effectivity of the characterization method of temperatures in weld zone of FSW based on infrared thermal imager is effective.

1. A method for temperature characterization of weld zone in friction stir welding (FSW) based on infrared thermal imager, the characteristic is, comprising the following steps:
step 1. a temperature field simulation model of FSW is established;
step 2. the data sets of temperature of surface feature points, the maximum and minimum temperatures in weld zone are extracted according to the simulation model result;
step 3. to design support vector regression machine algorithm model;
the usual starting point is a sample dataset (x₁, y₁), . . . , (x_{N}, y_{N}), where xᵢ (i=1, . . . , N) is the surface characteristic point temperature of the weldment, which is a one-dimensional input; yᵢ (i=1, . . . , N) is the weld zone temperature including the maximum temperature and the minimum temperature, which is a one-dimensional target; the basic idea of SVR is to map the data in the original input space into a high-dimensional feature space through a nonlinear transformation φ(x); in this high-dimensional feature space, the ε-insensitive loss function is used for linear regression to obtain the nonlinear regression relationship between the target quantity and the input quantity in the original space; the relationship between the surface temperature of weldment and the temperature of weld zone is obtained; the optimal linear function constructed in high dimensional feature space:
f(x)=w^{T}*ϕ(x)+b (1)
where w is the weight vector, b is the bias term; the ε-insensitive loss function is defined as:
$${L}_{ε} ( z ) = \{ \begin{matrix}0 , & \vert z \vert \leq ε \\ \vert z \vert - ε , & otherwi s e\end{matrix} \qquad ( 2 )$$
the objective function of SVR optimization is then as follows:
$$\begin{matrix}min \{ \frac{1}{2} {‖ w ‖}^{2} + C {\sum }_{i = 1}^{N} {L}_{ε} ( f ( {x}_{i} ) - {y}_{i} ) \} \\ s . t . {y}_{i} - ( {w}^{T} \cdot φ ( {x}_{i} ) + b ) \leq ε + {ξ}_{i}^{*} \\ {w}^{T} \cdot φ ( {x}_{i} ) + b - {y}_{i} \leq ε + {ξ}_{i}\end{matrix} \qquad ( 3 )$$
where C>0 is the penalty coefficient, considering the possible errors and introducing two slack variables ξᵢ, ξ*ᵢ, the optimization function is then as follows:
$$\begin{matrix}min \{ \frac{1}{2} {‖ w ‖}^{2} + C {\sum }_{i = 1}^{N} ( {ξ}_{i} + {ξ}_{i}^{*} ) \} \\ s . t . {y}_{i} - ( {w}^{T} \cdot φ ( {x}_{i} ) + b ) \leq ε + {ξ}_{i}^{*} \\ {w}^{T} \cdot φ ( {x}_{i} ) + b - {y}_{i} \leq ε + {ξ}_{i} \\ {ξ}_{i} , {ξ}_{i}^{*} \geq 0\end{matrix} \qquad ( 4 )$$
to solve formula (4), the Lagrange function is introduced:
$$L ( w , b ; α , {α}^{*} ) = \frac{1}{2} {‖ w ‖}^{2} - {\sum }_{i = 1}^{N} {α}_{i} ( ε + {y}_{i} - ( w \cdot φ ( {x}_{i} ) + b ) ) - {\sum }_{i = 1}^{N} {α}_{i}^{*} ( ε - {y}_{i} + ( w \cdot φ ( {x}_{i} ) + b ) ) \qquad ( 5 )$$
where, α=[α₁, . . . , α_{N}]^{T}≥0, α*=[α*₁ . . . , α*_{N}]^{T}≥0 is the Lagrange multiplier; taking partial differential of w and b respectively and making them equal to 0, the dual problem of Equation (5) is:
$$\begin{matrix}min \frac{1}{2} {\sum }_{i , j = 1}^{N} ( {α}_{i} - {α}_{i}^{*} ) ( {α}_{j} - {α}_{j}^{*} ) k ( {x}_{i} , {x}_{j} ) + ε {\sum }_{i = 1}^{N} ( {α}_{i} + {α}_{i}^{*} ) - {\sum }_{i = 1}^{N} {y}_{i} ( {α}_{i} - {α}_{i}^{*} ) \\ s . t . {\sum }_{i = 1}^{N} ( {α}_{i} - {α}_{i}^{*} ) = 0 \\ 0 \leq {α}_{i}^{*} \leq C , 0 \leq {α}_{i} \leq C , i = 1 , … , N\end{matrix} \qquad ( 6 )$$
where k(xᵢ,xⱼ) is the kernel function, RBF kernel function is selected, which has the advantages of good smoothness, radial symmetry and simple parameters; the function is as follows:
$$k ( {x}_{i} , {x}_{j} ) = {e}^{\frac{{‖ {x}_{i} - {x}_{j} ‖}^{2}}{2 {σ}^{2}}} \qquad ( 7 )$$
where σ>0 is an adjustable nuclear parameter;
solve Equation (6) to obtain a regression estimate of SVR as follows:
$$f ( x ) = {\sum }_{i , j = 1}^{N} ( {α}_{i} - {α}_{i}^{*} ) k ( {x}_{i} , {x}_{j} ) + b \qquad ( 8 )$$
step 4. setting the parameters and kernel function of the support vector regression algorithm model; the divided training and test temperature data sets of the feature point and weld zone are inputted in the model;
step 5. taking the root mean square error as the evaluation standard, the support vector regression machine algorithm model in step 3 is trained and tested;
step 6. the infrared thermal imager is arranged in front of the FSW machine, and the friction stir welding experiments are carried out; the temperature of the surface feature point on the weldment during the welding is obtained by the infrared thermal imager; taking the temperature of the feature points on the weldment as input to predict the maximum and minimum temperatures of the weld zone during the welding.
